(19) United States
(12) Patent Application Publication
(10) Pub. No.: US 2006/0094812 A1
(43) Pub. Date: May 4, 2006

(54) Process for the preparation of silver-containing polymer beads

(76) Inventors: Wolfgang Podszun, Koln (DE); Reinhold Klipper, Koln (DE); Olaf Halle, Koln (DE); Rudolf Wagner, Koln (DE); Ernest Henri De Ruiter, Leverkusen (DE)

Correspondence Address: LANXESS CORPORATION, 111 RIDC PARK WEST DRIVE, PITTSBURGH, PA, 15275-1112, US

(21) Appl. No.: 11/249,533

(22) Filed: Oct. 13, 2005

(30) Foreign Application Priority Data
Oct. 30, 2004 (DE) 1020040527202

(51) Int. Cl. C08L 9/08

(52) U.S. Cl. 524/460

(57) ABSTRACT

The present invention relates to a process for the preparation of silver-containing polymer beads, characterized in that I) a mixture of a) styrene b) crosslinker c) organic silver salt d) free-radical initiator and, if appropriate, e) inerting agent is produced, and II) the resultant mixture is cured in an aqueous phase at an increased temperature to form polymer beads.

The present invention relates to a process for the preparation of silver-containing polymer beads based on crosslinked polystyrene.

### BACKGROUND OF THE INVENTION

Polymer beads made of crosslinked polystyrene are used in various ways for the preparation of ion exchangers, adsorbers and chromatography resins. The particle size of conventional polymer beads is in a range of 50-500 μm.

In many applications, liquids or gases flow through column-type filters filled with spherical ion exchangers, chromatography resins or adsorbers. It has now been found that microbial infection of the ion exchangers, chromatography resins or adsorbers can be a considerable problem in practice. This microbial infection must be reliably prevented particularly in the purification of drinking water and the treatment of solutions in the food industry. One way for preventing the release of bacteria or other microorganisms from the filter unit to the liquids or gases to be treated is that the filter unit including the ion exchangers, chromatography resins or adsorbers contained therein are disinfected at defined time intervals. However, this method has the disadvantage that the productivity of the filter unit is decreased. In addition, generally, the service life of the ion exchangers, chromatography resins or adsorbers is shortened by the action of the disinfectant.

It is known to employ silver or silver salts as biocidal additives in the use of ion exchangers. However, the doping of finished ion exchangers is difficult in practice. If the bonding of the silver-containing additive is not sufficiently strong, the additive is washed out during use and the activity disappears. There is therefore a requirement for silver-containing ion exchangers, chromatography resins or adsorbers which have a biocidal activity and do not lose this during long-term use. It has now been found that such ion exchangers, chromatography resins or adsorbers can be obtained when these are produced by functionalizing silver-containing polymer beads based on crosslinked polystyrene.

The object of the present invention is the provision of crosslinked polystyrene polymer beads which are doped with silver or silver salts as starting material for ion exchangers, adsorbers and chromatography resins.

### SUMMARY OF THE INVENTION

A process has been found for the preparation of silver-containing polymer beads which is characterized in that
I) a mixture of
   a) styrene
   b) crosslinker
   c) organic silver salt
   d) free-radical initiator and, if appropriate,
   e) inerting agent is produced, and
II) the resultant mixture is cured in an aqueous phase at 60 to 130° C. to form polymer beads.

Styrene (a) for the purposes of the invention is taken to mean, in addition to unsubstituted styrene, also substituted styrenes, for example vinylnaphthalene, vinyltoluene, ethylstyrene, α-methylstyrene and chlorostyrenes.

Crosslinkers (b) are compounds which contain, per molecule, two or more, preferably two to four, double bonds which can be polymerized by free-radical mechanisms. Those which may be mentioned by way of example are: divinylbenzene, divinyltoluene, trivinylbenzene, divinylnaphthalene, trivinylnaphthalene, diethylene glycol divinyl ether, octadi-1,7-ene, hexadi-1,5-ene, diethylene glycol divinyl ether and butanediol divinyl ether.

The fraction of crosslinker is generally 1 to 80% by weight, preferably 2 to 16% by weight, based on the sum of the components (a) and (b).

Organic silver salt (c) for the purposes of the invention is taken to mean salts of monobasic and polybasic carboxylic acids and complexing agents. Those which may be mentioned by way of example are: silver formate, silver acetate, silver trifluoroacetate, silver propionate, silver pentafluoropropionate, 4-cyclohexylbutyric acid silver salt, silver 2-ethylhexanoate, silver octanoate, silver decanoate, silver laurate, silver stearate, silver behenate, silver benzoate, silver lactate, silver tartrate, silver citrate and silver acetylacetonate. Polymerizable silver salts, such as silver acrylate and silver methacrylate, are also highly suitable.

The organic silver salt (c) can be partly or completely soluble in the mixture of the components (a) and (b). However, solubility is not a precondition for carrying out the inventive process. Silver salts which are not soluble, or are not completely soluble, in (a) and (b) are used in finely divided suspended form. The finely divided suspension can be produced by customary methods, for example using high-speed agitators, rotor-stator mixers, ball mills or pearl mills. An additional treatment with ultrasound is also advantageous. Finely divided in this context means that the size of the silver salt particles is in the range of 10 nm-20 μm, preferably 100 nm-10 μm.

The amount of the organic silver salt (c) is 0.001-10% by weight, preferably 0.01-2% by weight, particularly preferably 0.03-1% by weight, based on the components a, b and c.

For activation, use may be made of conventional monomer-soluble free-radical formers (d). Those which may be mentioned by way of example are: peroxide and azo compounds, such as dibenzoyl peroxide, dilauroyl peroxide, cyclohexyl percarbonate and azoisobutyrodinitrile. Mixtures of polymerization initiators having different decomposition temperatures are also highly suitable. In order to avoid premature start of polymerization, it is expedient not to add the initiator until immediately before dispersion. The free-radical former is used in an amount of 0.05-2% by weight, preferably 0.1-0.8% by weight, based on the sum of the components a and b.

Suitable inerting agents (e) are water-immiscible, organic liquids. Those which may preferably be mentioned are aliphatic or aromatic hydrocarbons and alcohols having up to 20 carbon atoms, such as hexane, heptane, isodecane, benzene, toluene or octanol, halogenated hydrocarbons, such as di-, tri-, tetrachloromethane or 1,2-dichloroethane, esters, such as methyl acetate, butyl acetate, or dialkyl carbonates and water-insoluble ketones, such as methyl isobutyl ketone, or cyclohexanone. By the use of inerting agent, a porous structure can be produced in the inventive polymer beads.

The weight ratio of inerting agent to the sum of the components a and b is 0.1:1 to 3:1, preferably 0.5:1 to 2:1.

The activated silver-containing monomer mixture is dispersed by means of a water phase. To produce beads as uniform as possible, it is advantageous to charge the water phase and slowly add the monomer mixture with stirring.

The ratio of monomer phase to water phase is 1.2:1 to 1:6, preferably 1:1.3 to 1:3.

The water phase contains a dispersant. Suitable dispersants are all water-soluble macromolecular compounds known per se for this purpose, e.g. cellulose derivatives, such as methylcellulose, and partially saponified poly(vinyl acetate)s. Highly suitable compounds are also copolymers of (meth)acrylic acid and (meth)acrylic alkyl esters. Those which may be mentioned by way of example are the alkaline solution of a copolymer of methacrylic acid and methyl methacrylate. The content of dispersant is preferably 0.5 to 5% by weight, based on the water phase.

The polymerization is initiated by heating to the decomposition temperature of the polymerization initiator. Preferred polymerization temperatures are in the range from 60 to 90° C. The polymerization generally lasts some hours, for example 5 to 10 h. After the reaction has died down, the temperature can be further increased to, for example, 130° C., if appropriate under elevated pressure, e.g. 1 to 6 bar, preferably 1 to 3 bar.

From the polymerized dispersion, the polymer beads are isolated in the known manner by decanting, filtering, washing and drying.

The inventive polymer beads are outstandingly suitable as starting materials for ion exchangers, chelating resins, chromatography resins and adsorber resins. The end products produced therefrom show a significantly reduced rate of microbial infection.

The inventive polymer beads are functionalized to form ion exchangers by known methods. Strongly acidic ion exchangers may be produced by sulphonation using concentrated sulphuric acid, oleum, or chlorosulphonic acid. Anion exchangers are obtained by aminomethylation or chloromethylation with subsequent amination.

The inventive polymer beads are also outstandingly suitable for producing spherical activated carbon by carbonization reaction.

It will be understood that the specification and examples are illustrative but not limitative of the present invention and that other embodiments within the spirit and scope of the invention will suggest themselves to those skilled in the art.

### EXAMPLE 1

Preparation of Silver-Containing Polymer Beads

An aqueous solution of 5.4 g of methylhydroxyethylcellulose, 4.82 g of disodium hydrogen phosphate and 1900 g of deionized water was charged into a 4 l ground-glass joint reactor equipped with gate-type agitator, cooler, temperature sensor and also thermostat and recorder.

In a separate stirred vessel, 963.4 g of styrene and 49.89 g of divinylbenzene (81.2% strength by weight) were mixed. 5.25 g of silver behenate were added to the resultant mixture and dispersed for 4 min at 24 000 rpm using a rotor-stator mixer. 6.0 g of dibenzoyl peroxide were then added and dissolved in the resultant dispersion in the course of 20 min.

The activated dispersion was introduced through an elongated funnel with stirring at 240 rpm into the prepared 4 l ground-glass joint reactor at 55° C. below the surface of the aqueous phase. The mixture was then heated to 63° C., a nitrogen stream of 20/min being passed over in the first 15 min. The mixture was heated at 63° C. for 6 h, then the temperature was increased to 95° C. in the course of one hour and held at 95° C. for a further 2 h. After the mixture was cooled, the polymer was washed over a 100 μm screen with copious water, then dried at 80° C. This produces 950 g of uniform beads having an average particle size of 380 μm. The silver content was 0.1% by weight.

### EXAMPLE 2

Preparation of Silver-Containing Polymer Beads

In accordance with the procedure of Example 1, a mixture of 913.5 g of styrene and 99.8 g of divinylbenzene (81.2% strength by weight), 4.75 g of silver 2-ethylhexanoate and 6.0 g of dibenzoyl peroxide was cured to form polymer beads. This produced 968 g of uniform beads having an average particle size of 375 μm. The silver content is 0.2% by weight.

What is claimed is:

1. A process for the preparation of silver-containing polymer beads wherein
I) a mixture of
a) styrene
b) crosslinker
c) organic silver salt
d) free-radical initiator and, if appropriate,
e) inerting agent is produced, and
II) the resultant mixture is cured in an aqueous phase at 60 to 130° C. to form polymer beads.

2. A process according to claim 1, wherein 0.001-10% by weight of organic silver salt based on the sum of the components a, b and c is used.

3. A process according to claim 2, wherein the organic silver salt is silver formate, silver acetate, silver trifluoroacetate, silver propionate, silver pentafluoropropionate, 4-cyclohexylbutyric acid silver salt, silver 2-ethylhexanoate, silver octanoate, silver decanoate, silver laurate, silver stearate, silver behenate, silver benzoate, silver lactate, silver tartrate, silver citrate, silver acetylacetonate, silver acrylate or silver methacrylate.

4. A process according to claim 1, wherein the polymer beads are cured at a temperature of 60 to 90° C.

5. A method of use of the polymer beads obtained according to claim 1 as starting material for ion exchangers, chelating resins, chromatography resins and adsorber resins.

6. A method of use of the polymer beads obtained according to claim 1 as starting material for spherical activated carbon.
